(19) United States
(12) Patent Application Publication
(10) Pub. No.: US 2010/0309340 A1
(43) Pub. Date: Dec. 9, 2010

(54) IMAGE SENSOR HAVING GLOBAL AND ROLLING SHUTTER PROCESSES FOR RESPECTIVE SETS OF PIXELS OF A PIXEL ARRAY

(76) Inventors: John N. Border, Walworth, NY (US); John T. Compton, LeRoy, NY (US)

Correspondence Address: Pedro P. Hernandez;Eastman Kodak Company, Patent Legal Staff, 343 State Street, Rochester, NY, 14650-2201, US

(21) Appl. No.: 12/477,157

(22) Filed: Jun. 3, 2009

(51) Int. Cl. H04N 5/335; H04N 5/217

(52) U.S. Cl. 348/241; 348/296; 348/E05.091

(57) ABSTRACT

A CMOS image sensor or other type of image sensor includes a pixel array comprising at least first and second sets of pixels. Image sensor circuitry is coupled to the pixel array and comprises a signal generator for controlling capture of image data from the first set of pixels of the pixel array using a global shutter process and for controlling capture of image data from the second set of pixels of the pixel array using a rolling shutter process, with the pixels of the second set being different than the pixels of the first set The image sensor may be implemented in a digital camera or other type of digital imaging device.

### FIELD OF THE INVENTION

The present invention relates generally to electronic image sensors for use in digital cameras and other types of imaging devices, and more particularly to image readout in an electronic image sensor.

### BACKGROUND OF THE INVENTION

A typical electronic image sensor comprises a number of photodiodes or other photosensitive elements arranged in a two-dimensional array. These elements are also commonly referred to as picture elements or “pixels” and the corresponding array is referred to as a pixel array. Light incident on the pixel array is converted to electrical charge by the photosensitive elements. Collected electrical charge for a given image capture period is read from the photosensitive elements of the pixel array using an active pixel sensor (APS) or charge-coupled device (CCD) arrangement.

As is well known, an APS image sensor may be implemented using complementary metal-oxide-semiconductor (CMOS) circuitry. An image sensor of this type is commonly referred to as a CMOS image sensor. In such an arrangement, each pixel comprises at least a photodiode and a transfer gate. The transfer gate is utilized to control the transfer of collected electrical charge from the photodiode to a sensing node in conjunction with image readout. The sensing node usually comprises a floating diffusion. Each pixel may include its own floating diffusion, or a single floating diffusion may be shared by a small group of pixels. As examples of the latter arrangement, groups of two, three or four pixels may each share a single floating diffusion. Each of the pixels of a given such group includes a transfer gate for controllably connecting the corresponding photodiode to the floating diffusion during image readout. Other readout circuitry may be shared between multiple pixels, such as a reset gate, an output transistor and a row select transistor.

Many CMOS image sensors utilize a so-called “rolling shutter” to control exposure to incident light. The rolling shutter is a type of on-chip electronic shutter that operates in a manner similar to a mechanical focal plane shutter in a film camera. The various processing operations associated with use of a rolling shutter in an image sensor are also collectively referred to herein as a “rolling shutter process.”

In a typical rolling shutter process, the rows of pixels in the image sensor are reset in sequence, starting at the top of the pixel array and proceeding row by row to the bottom. When this reset operation has moved some distance down the pixel array, the readout operation begins, with rows of pixels being read out in sequence, starting at the top of the pixel array and proceeding row by row to the bottom in exactly the same fashion and at the same speed as the reset operation. The rolling shutter process controls exposure time for each row and each pixel in a row by controlling the time delay between a given row being reset and that row being read out, also referred to as the integration time. For example, the integration time can be varied from a single line time (i.e., readout of a given row starts immediately after reset of that row is complete) up to a full frame time (i.e., reset of the bottom row in the pixel array is complete before readout of the top row begins) or more.

Although the use of a rolling shutter process avoids the cost and complexity of a mechanical shutter, it can also lead to undesirable motion artifacts in an output image. For example, if a vehicle is moving through the image field during capture, then light from the top of vehicle will be integrated at some earlier time than light from the bottom of the vehicle, causing the bottom of the vehicle to appear slanted forward in the direction of motion. The use of a rolling shutter process can also lead to other types of artifacts, such as different rows in a captured image exhibiting different levels of brightness due to different amounts of flash time.

A number of techniques are known in the art for correcting for motion artifacts in an image generated using a rolling shutter process. See, for example, U.S. Patent Application Publication No. 2007/0154202, entitled “Method and Apparatus to Facilitate Correcting Rolling Shutter Images,” and U.S. Patent Application Publication No. 2008/0144964, entitled “System, Method, Device, and Computer Program Product for Providing Image Correction.” However, these correction techniques fail to provide any substantial reduction in the generation of rolling shutter artifacts, and can significantly increase the cost and complexity of a digital camera or other digital imaging device.

Accordingly, a need exists for techniques for reducing motion artifacts and other artifacts attributable to use of a rolling shutter process, without significantly increasing the cost and complexity of the corresponding digital imaging device.

### SUMMARY OF THE INVENTION

Illustrative embodiments of the invention provide image sensors in which global shutter and rolling shutter processes are applied to respective sets of pixels of a pixel array in a manner that tends to reduce motion artifacts and other artifacts associated with conventional use of a rolling shutter process.

In accordance with one aspect of the invention, an image sensor includes a pixel array comprising at least first and second sets of pixels. Image sensor circuitry is coupled to the pixel array and comprises a signal generator for controlling capture of image data from the first set of pixels of the pixel array using a global shutter process and for controlling capture of image data from the second set of pixels of the pixel array using a rolling shutter process, with the pixels of the second set being different than the pixels of the first set.

The pixel array may comprise a plurality of floating diffusions with each such floating diffusion being shared between multiple pixels. For example, a given one of the floating diffusions may be shared between four of the pixels, in a 4T4S pixel sharing arrangement. As another example, a given one of the floating diffusions may be shared between two of the pixels, in a 4T2S pixel sharing arrangement.

More particularly, a given one of the floating diffusions may be shared between at least one pixel of the first set of pixels and at least one pixel of the second set of pixels such that the given floating diffusion is used for capture of image data from said at least one pixel of the first set of pixels using the global shutter process and is also used for capture of image data from said at least one pixel of the second set of pixels using the rolling shutter process.

It is also possible that each pixel of the pixel array may have its own floating diffusion.

In a given one of the illustrative embodiments, the pixel array of the image sensor is configured in accordance with a sparse color filter array pattern that includes color pixels and panchromatic pixels, and the first set of pixels from which image data is captured using the global shutter process is comprised substantially entirely of panchromatic pixels. The second set of pixels comprises primarily color pixels, but may also include some panchromatic pixels.

In accordance with another aspect of the invention, the pixel array may further comprise a third set of pixels, with the pixels of the third set being different than the pixels of the first and second sets, and with the signal generator being operative to control capture of image data from the third set of pixels utilizing an additional global shutter process. The additional global shutter process utilized in capturing image data from the third set of pixels may have an exposure time which is different than that of the global shutter process utilized in capturing image data from the first set of pixels. Also, the additional global shutter process utilized in capturing image data from the third set of pixels may have an exposure time which at least partially overlaps an exposure time of the global shutter process utilized in capturing image data from the first set of pixels.

In accordance with yet another aspect of the invention, a global shutter image generated using the global shutter process and a rolling shutter image generated using the rolling shutter process are further processed in order to generate at least one additional image. The additional image may be, for example, a corrected rolling shutter image that is corrected for motion artifacts using the global shutter image, or a combined image generated by combining at least a portion of the global shutter image with at least a portion of the rolling shutter image.

An image sensor in accordance with the invention may be advantageously implemented in a digital camera or other type of imaging device, and provides substantial reduction in motion artifacts and other artifacts attributable to use of a rolling shutter process, without significantly increasing the cost or complexity of the imaging device.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of a digital camera having an image sensor configured in accordance with an embodiment of the invention;

FIG. 2 is a block diagram showing a more detailed view of a portion of the image sensor of the digital camera of FIG. 1;

FIG. 3A is a schematic diagram of one possible implementation of a portion of a pixel array in the image sensor of the digital camera of FIG. 1;

FIG. 3B illustrates the pixel circuitry of the 4T4S pixel arrangement of FIG. 3A;

FIG. 3C illustrates alternative pixel circuitry in a 4T2S pixel arrangement;

FIG. 4 illustrates an image data capture process implemented in the FIG. 1 digital camera for a pixel array comprising a 4T4S pixel arrangement, with a global shutter process applied to a first set of pixels of the pixel array and a rolling shutter process applied to a second set of pixels of the pixel array;

FIG. 5 is a flow diagram of the image data capture process of FIG. 4;

FIGS. 6 through 8 illustrate other examples of image data capture processes that may be implemented in the FIG. 1 digital camera for a pixel array comprising a 4T4S pixel arrangement, with a global shutter process applied to a first set of pixels of the pixel array and a rolling shutter process applied to a second set of pixels of the pixel array;

FIGS. 9 through 11 illustrate additional examples of image data capture processes that may be implemented in the FIG. 1 digital camera for a pixel array comprising a 4T2S pixel arrangement, with a global shutter process applied to a first set of pixels of the pixel array and a rolling shutter process applied to a second set of pixels of the pixel array.

### DETAILED DESCRIPTION OF THE INVENTION

The present invention will be illustrated herein in conjunction with particular embodiments of digital cameras, image sensors, image sensor circuitry and associated image readout techniques. It should be understood, however, that these illustrative arrangements are presented by way of example only, and should not be viewed as limiting the scope of the invention in any way. Those skilled in the art will recognize that the disclosed arrangements can be adapted in a straightforward manner for use with a wide variety of other types of imaging devices, image sensors, image sensor circuitry and associated image readout techniques.

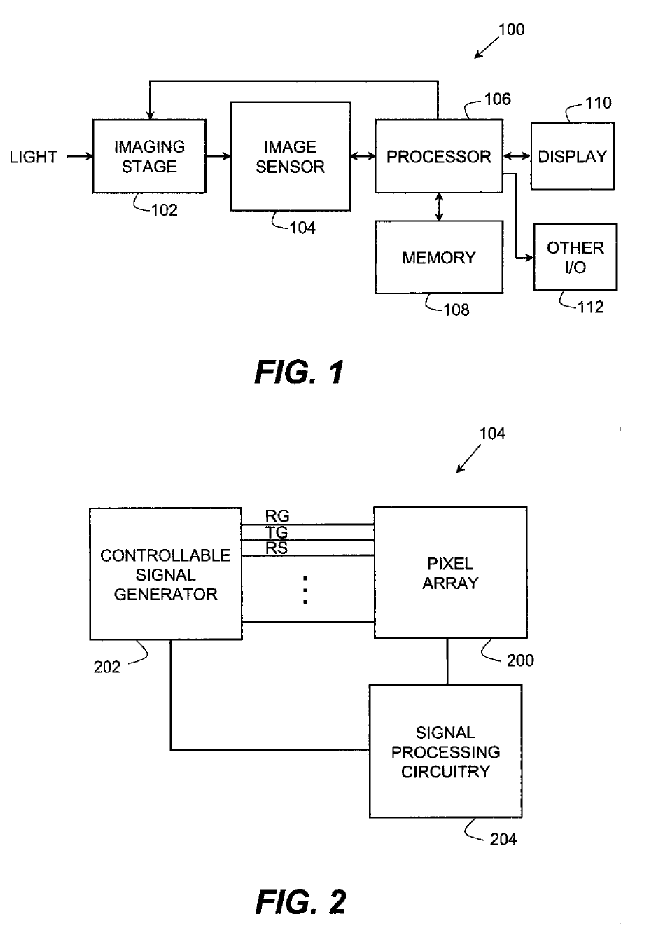

FIG. 1 shows a digital camera 100 in an illustrative embodiment of the invention. In the digital camera, light from a subject scene is input to an imaging stage 102. The imaging stage may comprise conventional elements such as a lens, a neutral density filter, an iris and a shutter. The light is focused by the imaging stage 102 to form an image on an image sensor 104, which converts the incident light to electrical signals. The digital camera 100 further includes a processor 106, a memory 108, a display 110, and one or more additional input/output (I/O) elements 112.

Although shown as separate elements in the embodiment of FIG. 1, the imaging stage 102 may be integrated with the image sensor 104, and possibly one or more additional elements of the digital camera 100, to form a compact camera module.

The image sensor 104 will typically be implemented as a color image sensor having an associated color filter array (CFA) pattern. One type of CFA pattern that may be used in the image sensor 104 is the well-known Bayer pattern, disclosed in U.S. Pat. No. 3,971,065, entitled “Color Imaging Array,” which is incorporated by reference herein. Other examples of CFA patterns that may be used in image sensor 104 include those disclosed in U.S. Patent Application Publication No. 2007/0024931, entitled “Image Sensor with Improved Light Sensitivity,” which is incorporated by reference herein. These include patterns which provide certain of the pixels with a panchromatic photoresponse. Such patterns are also generally referred to herein as “sparse” CFA patterns. Image sensors configured with sparse CFA patterns exhibit greater light sensitivity and are thus well-suited for use in applications involving low scene lighting, short exposure time, small aperture, or other restrictions on the amount of light reaching the image sensor.

It should be noted that the image sensor 104 need not be a color image sensor having a CFA. For example, the image sensor may comprise a monochrome image sensor or an infrared image sensor.

The processor 106 may comprise, for example, a microprocessor, a central processing unit (CPU), an application-specific integrated circuit (ASIC), a digital signal processor (DSP), or other processing device, or combinations of multiple such devices. Various elements of the imaging stage 102 and the image sensor 104 may be controlled by timing signals or other signals supplied from the processor 106.

The memory 108 may comprise any type of memory, such as, for example, random access memory (RAM), read-only memory (ROM), Flash memory, disk-based memory, removable memory, or other types of storage elements, in any combination.

A given image captured by the image sensor 104 may be stored by the processor 106 in memory 108 and presented on display 110. The display 110 is typically an active matrix color liquid crystal display (LCD), although other types of displays may be used. The additional I/O elements 112 may comprise, for example, various on-screen controls, buttons or other user interfaces, network interfaces, memory card interfaces, etc.

Additional details regarding the operation of a digital camera of the type shown in FIG. 1 can be found, for example, in the above-cited U.S. Patent Application Publication No. 2007/0024931.

The image sensor 104 is assumed in the present embodiment to be a CMOS image sensor, although other types of image sensors may be used in implementing the invention.

As shown in FIG. 2, image sensor 104 more particularly comprises a pixel array 200, a controllable signal generator 202 and signal processing circuitry 204. In other embodiments, one or both of elements 202 and 204 may be arranged at least in part external to the image sensor.

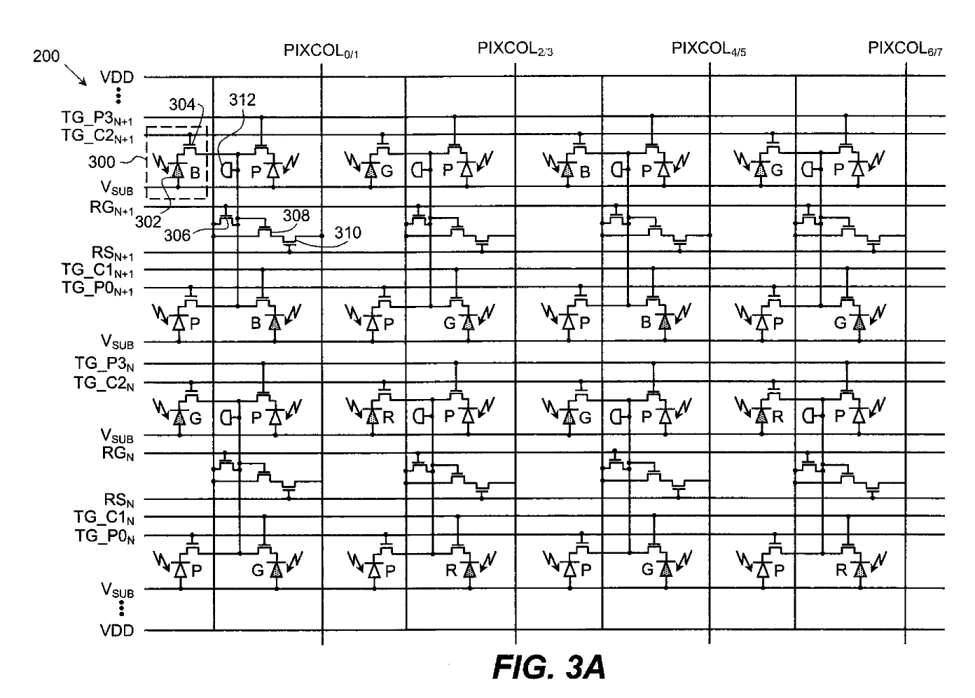

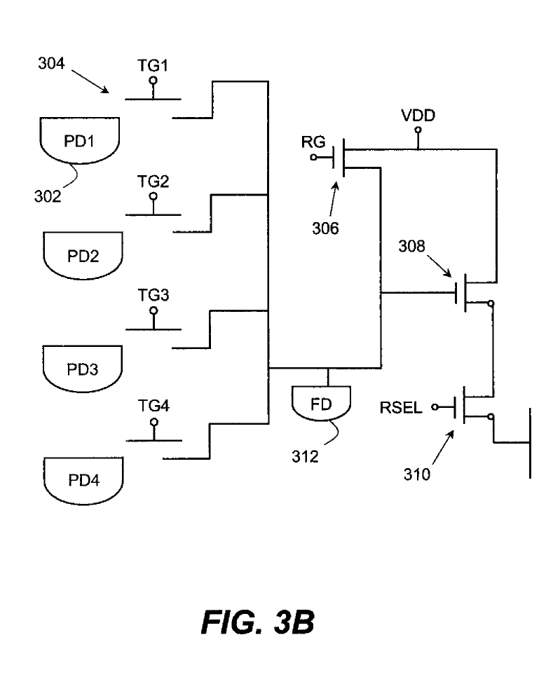

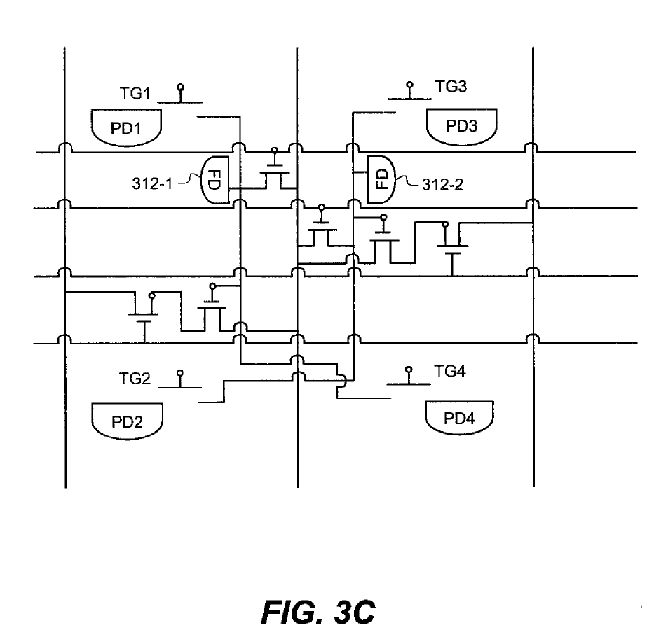

The pixel array 200 generally includes a plurality of pixels arranged in rows and columns as well as additional circuitry associated with readout of the pixel array, a more detailed example of which will be described below in conjunction with FIG. 3A. Each pixel of the pixel array generally comprises at least a photodiode or other type of photosensitive element coupled to a transfer gate.

The controllable signal generator 202 may operate under control of the processor 106 to generate signals associated with readout of the pixel array 200, including, by way of example, reset gate (RG) signals, transfer gate (TG) signals and row select (RS) signals, as indicated in FIG. 2. Other types of signals associated with image readout, including sampling signals such as sample-and-hold reset (SHR) and sample-and-hold signal (SHS), may also be generated by the signal generator 202.

The signal generator 202 may comprise drive circuitry of a type generally known in the art, suitably modified to implement global shutter and rolling shutter processes as described herein. The term “signal generator” as used herein is intended to be construed broadly, so as to encompass any arrangement of circuitry used to generate signals for application to a pixel array in implementing a global shutter or rolling shutter process.

The signal processing circuitry 204 may comprise, for example, one or more analog signal processors (ASPs) for processing analog signals read out from the pixel array 200, one or more programmable gain amplifiers (PGAs) for amplifying such signals, and one or more analog-to-digital converters (ADCs) for converting the amplified signals to a digital form suitable for processing by processor 106. Portions of such signal processing circuitry may be arranged external to the image sensor, or formed integrally with the pixel array 200, for example, on a common integrated circuit with photosensitive elements and other readout circuitry elements of the pixel array 200.

Functionality associated with readout of the pixel array 200 and the processing of corresponding image data may be implemented at least in part in the form of software that is stored in memory 108 and executed by processor 106. For example, the various signals generated by the controllable signal generator 202 may be selected or otherwise configured responsive to execution of software by the processor 106. Such software can be implemented in a straightforward manner given the teachings provided herein, as will be appreciated by those skilled in the art.

It is to be appreciated that the digital camera 100 and image sensor 104 as shown in FIGS. 1 and 2 may comprise additional or alternative elements of a type known to those skilled in the art. Elements not specifically shown or described herein may be selected from those known in the art. These and other figures described herein are simplified in order to clearly illustrate various aspects of the present invention, and are not necessarily drawn to scale. A given embodiment may include a variety of other features or elements that are not explicitly illustrated but would be familiar to one skilled in the art as being commonly associated with digital cameras, image sensors or image sensor circuitry of the general type described.

As noted above, a problem with conventional image sensors that use rolling shutter processes is that images generated by such sensors may contain motion artifacts or other types of artifacts. The image sensor 104 is configured in the illustrative embodiments to reduce such artifacts through application of global and rolling shutter processes to respective sets of pixels of the pixel array 200.

FIG. 3A shows a portion of pixel array 200 in the image sensor 104 in an illustrative embodiment. The portion shown includes only 32 pixels, for simplicity and clarity of illustration, but a typical practical implementation of a pixel array will include a substantially larger number of pixels, arranged in a manner similar to those that are shown.

Each pixel 300 of the pixel array 200 comprises a photodiode 302 coupled to a first transistor 304. Additional circuitry comprising a second transistor 306, a third transistor 308, a fourth transistor 310 and a floating diffusion 312 is shared by a subarray of four pixels arranged in a 2×2 block. The 2×2 pixel block is one example of what is more generally referred to herein as a “cell.” There is a different set of additional circuitry associated with each of the 2×2 pixel cells. The configuration of pixel array 200 in this embodiment is referred to as a four transistor, four shared (4T4S) arrangement, as the basic pixel structure comprises a total of four transistors 304, 306, 308 and 310, with four of the pixels sharing the additional circuitry comprising transistors 306, 308 and 310 and the floating diffusion 312.

The transistors of the pixel array in this embodiment are n-type MOS (NMOS) transistors. Typically, such transistors and the associated photodiode are formed in a p-well region on an n-type substrate. In an alternative implementation of NMOS pixel transistors, the NMOS transistors are formed in a p-type epitaxial layer grown on a p-type substrate. In other embodiments, the pixel transistors may be p-type MOS (PMOS) transistors, in which case the photodiode and the transistors may be formed, for example, in an n-well region on a p-type substrate.

The first transistor 304 is a transfer gate configured to transfer collected charge from the photodiode 302 to floating diffusion 312 responsive to a transfer gate (TG) signal. The second transistor 306 is a reset gate configured to reset the floating diffusion 312 by coupling it to a pixel power supply voltage Vdd responsive to a reset gate (RG) signal. The second transistor 306 can also be used to reset the photodiode 302 and the floating diffusion 312 simultaneously when operated in conjunction with the first transistor 304. The third transistor 308 is a source follower or output transistor configured to amplify the signal on the floating diffusion and to supply the amplified signal to a common output line denoted PixCol_{n/n+1} and associated with columns n and n+1 of the pixel array, where n=0, 2, 4, etc. In this embodiment, the output transistor is coupled to the common output line via the fourth transistor 310, which is a row select transistor operative responsive to a row select (RS) signal as shown.

Elements of the pixel array 200 in FIG. 3A are coupled to supply voltage Vdd and substrate voltage Vsub as shown. Control signals applied to the pixel array include TG control signals TG_P0, TG_C1, TG_C2 and TG_P3, as well as additional control signals including RG signals and RS signals. The subscripts N+1 and N associated with these signals refer to respective upper and lower row pairs in the array.

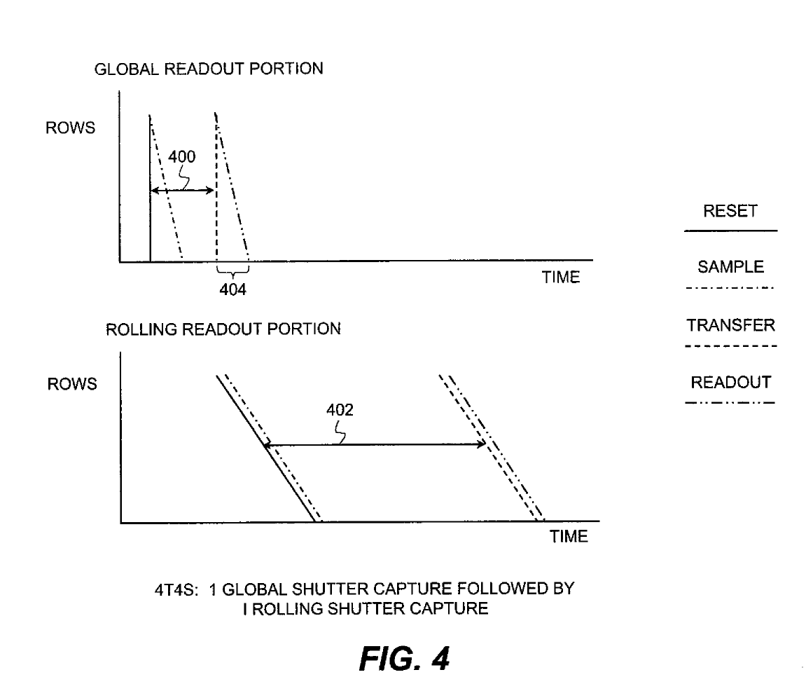

The RG, TG and RS signals are part of a group of control signals generated by signal generator 202 and applied to the pixel array 200 to control the capture of image data using global and rolling shutter processes as will be described in conjunction with FIGS. 4 through 11 below.

As indicated previously, FIG. 3A illustrates a 4T4S arrangement in which a given reset gate 306, output transistor 308, row select transistor 310 and floating diffusion 312 are shared among four pixels. FIG. 3B shows another view of this exemplary sharing 4T4S arrangement. In this diagram, four photodiodes 302, also denoted PD1, PD2, PD3 and PD4, having respective transfer gates TG1, TG2, TG3 and TG4, share a single floating diffusion 312.

Other types of sharing arrangements are possible, including, for example, 4T2S arrangements in which such elements are shared among two pixels. Another exemplary 4T2S arrangement shares a reset gate, output transistor and row select transistor among two pixels, but provides a separate floating diffusion for each pixel. Also, a given embodiment could provide each pixel with its own reset gate, output transistor, row select transistor and floating diffusion, such that there is no sharing of these elements among different pixels.

FIG. 3C shows an example of pixel circuitry in a 4T2S sharing arrangement in which two photodiodes PD1 and PD4 share a first floating diffusion 312-1 and two other photodiodes PD2 and PD3 share a second floating diffusion 312-2.

Numerous other alternative arrangements of image sensor circuitry may be used in implementing a given embodiment of the invention. For example, although illustrative embodiments described herein utilize 4T pixels, other types of pixel structures may be used. Conventional aspects of such circuitry are well understood by those skilled in the art and will therefore not be described in further detail herein.

Also illustrated in FIG. 3A is the CFA pattern associated with the pixel array 200. More specifically, adjacent each of the pixels 300 in the pixel array is an indicator of its corresponding color filter element, which may be red (R), blue (B), green (G) or panchromatic (P), in accordance with a designated sparse CFA pattern of the image sensor 104. The particular sparse CFA pattern used in the illustrative embodiments described herein is a panchromatic checkerboard pattern disclosed in the above-cited U.S. Patent Application Publication No. 2007/0024931, although numerous other CFA patterns may be used.

The portion of the array 200 shown in FIG. 3A includes four rows of eight pixels each, with the two upper rows of this portion being referred to herein as a blue/green row pair, and the two lower rows being referred to herein as a red/green row pair. The minimal repeating unit in this particular CFA pattern is a subarray of 16 contiguous pixels comprising the left half or right half of the portion of the pixel array 200 as shown in FIG. 3A. Thus, the minimal repeating unit comprises 16 pixels arranged in four four-pixel cells as follows:
ZPYP
PZPY
YPXP
PYPX
   where P represents one of the panchromatic pixels and X, Y and Z represent respective color pixels. In this particular embodiment, X, Y and Z are red, green and blue, respectively. Alternatively, X, Y and Z may be individually selected in a different manner from red, green and blue, or may be individually selected from another set of colors, such as cyan, magenta and yellow. Patterns with other minimal repeating units, such as minimal repeating units of at least twelve pixels as described in the above-cited U.S. Patent Application Publication No. 2007/0024931, may be used.

The columns in the portion of the pixel array 200 shown in FIG. 3A are separated into groups, with each group comprising two of the columns and sharing a common output. For example, the pixels in the first two columns at the left side of the array share the common output denoted PixCol_{0/1}. Similarly, the pixels in the next two columns of the array share the common output denoted PixCol_{2/3}. The remaining two pairs of columns share the respective common outputs denoted PixCol_{4/5} and PixCol_{6/7}. Each pixel in a given one of the 2×2 pixel cells is connectable to its shared common output via an output transistor and row select transistor associated with that cell.

The pixel array 200 of FIG. 3A is advantageously configured to permit binning of same-color pixels and binning of panchromatic pixels. The term “binning” as used herein is intended to encompass arrangements that involve, for example, simultaneously connecting two or more pixels from the same pixel cell to the same common output prior to sampling that output. Other types of binning may also be used. Alternative embodiments of the invention need not be configured to facilitate such binning operations.

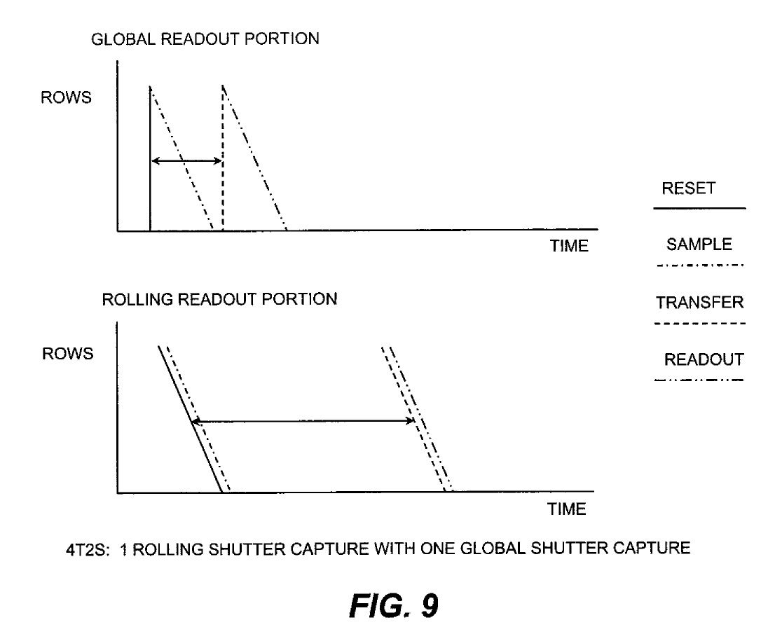

Exemplary data capture processes implemented in digital camera 100 in illustrative embodiments of the invention will now be described with reference to FIGS. 4 through 11. FIGS. 4 through 8 assume the use of a 4T4S pixel structure such as that illustrated in FIGS. 3A and 3B, while FIGS. 9 through 11 involve an alternative 4T2S pixel structure such as that illustrated in FIG. 3C. In the exemplary processes to be described, the signal generator 202 controls capture of image data from a first set of pixels of the pixel array 200 using a global shutter process, and controls capture of image data from a second set of pixels of the pixel array using a rolling shutter process, where the pixels of the second set are different than the pixels of the first set. As will be described, this type of arrangement advantageously allows motion artifacts and other artifacts in images generated by the readout process to be reduced.

Turning now to FIG. 4, an image data capture process is illustrated for the pixel array 200 of FIG. 3A. This process includes a global readout portion comprising a single capture with a global shutter process and a rolling readout portion comprising another single capture using a rolling shutter process. Both the global shutter process and the rolling shutter process include operations for reset of the photodiode and floating diffusion, sampling of the floating diffusion, transfer of the charge from the photodiode to the floating diffusion, and readout of the floating diffusion, with these reset, sample, transfer and readout operations being indicated by respective solid or dashed lines as shown. The figure illustrates the manner in which these operations are applied to rows of the pixel array 200 as a function of time.

In this embodiment, the global shutter process is used to capture image data from panchromatic pixels of the pixel array 200, and the rolling shutter process is used to capture image data from the color pixels R, G and B of the pixel array. Thus, the above-noted first and second sets of pixels in this embodiment comprise primarily panchromatic pixels and primarily color pixels, respectively. A wide variety of other types of groupings are possible. For example, the first set need not contain only panchromatic pixels, but may instead also include some color pixels. Similarly, the second set need not contain only color pixels, but may instead also include some panchromatic pixels. However, it is generally desirable for the first set of pixels to include pixels that are more sensitive to light than the pixels of the second set, as the global shutter capture will typically have a shorter exposure time than the rolling shutter capture to reduce motion artifacts. Thus, panchromatic pixels are preferred for inclusion in the first set of pixels subject to the global shutter process. The percentage of the total number of pixels included in the first set of pixels may be on the order of 25% of the pixels, although other percentages may be used.

In the FIG. 4 embodiment, the global shutter process has an exposure time 400, and the rolling shutter process has an exposure time 402 that is substantially longer than the exposure time 400. These exposure times are measured between reset of a given photodiode and its corresponding floating diffusion and transfer of collected charge from that photodiode to the floating diffusion. For the global shutter process, the reset operation occurs substantially simultaneously for all of the pixels that are subject to the global shutter, regardless of what row the pixels are in, as does the transfer operation. Accordingly, the reset and transfer operations for the global shutter process are illustrated by respective vertical lines. For the rolling shutter process, the reset and transfer operations proceed by row, and are thus illustrated by respective diagonal lines. In contrast, the sample and readout processes for both the global shutter process and the rolling shutter process are processed sequentially by row so that diagonal lines are shown with a slope that is indicative of the number of pixels in each image.

It can be seen from FIG. 4 that the start of the rolling shutter image capture process approximately coincides with the transfer operation of the global shutter image capture process. Thus, readout time 404 of the global shutter image capture process can at least partially overlap the exposure time of the rolling shutter image capture process as applied to the initial rows for which image data is captured using the rolling shutter process. The readout time denotes the time period in which the voltage produced by the charge transferred to the floating diffusions in the transfer operation is read out from the floating diffusions. It should be noted that for a given floating diffusion, the voltage produced by the charge from the first image which in this case is the global shutter image must be read out before the floating diffusion can be reset or sampled as part of the second image which in this case is the rolling shutter image.

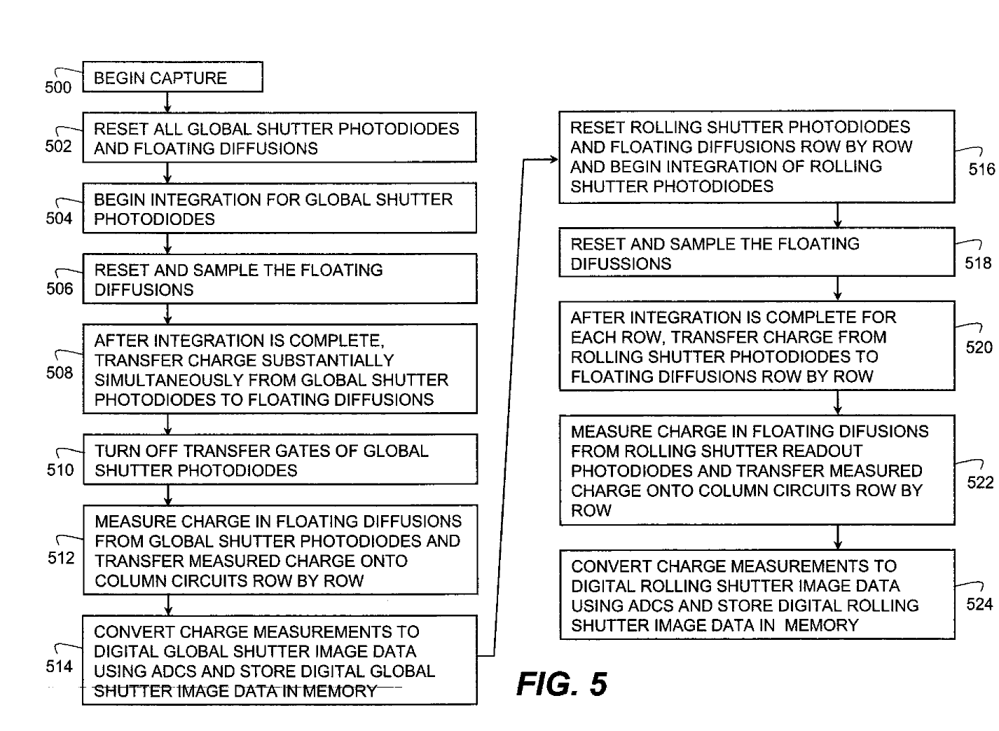

Referring now to FIG. 5, a flow diagram is shown illustrating the overall image data capture process of FIG. 4 in greater detail. Steps 502 through 514 correspond to the global shutter image data capture, while steps 516 through 524 correspond to the rolling shutter image data capture. As previously indicated, the global shutter process is used to capture image data from a first set of pixels of the pixel array 200, such as the panchromatic pixels, and the rolling shutter process is used to capture image data from a second set of pixels of the pixel array 200, such as the color pixels. These first and second sets of pixels are referred to in the context of the flow diagram and elsewhere herein as global shutter pixels and rolling shutter pixels, respectively, and their associated photodiodes are referred to as global shutter photodiodes and rolling shutter photodiodes, respectively. However, it should be noted that pixels and photodiodes and the electronic shutter process used to obtain images from the pixels and photodiodes can be changed from a global shutter process to a rolling shutter process for example, during a change in camera operating mode.

Image data capture begins in step 500, and all global shutter photodiodes and floating diffusions are reset in step 502. The integration of charge for the global shutter photodiodes begins in step 504. This part of the process involves resetting and sampling the corresponding floating diffusions in step 506. After integration of the global shutter photodiodes is complete, charge is transferred substantially simultaneously from the global shutter photodiodes to the floating diffusions, as indicated in step 508. The transfer gates of the global shutter photodiodes are turned off in step 510. The readout operation then begins in step 512 by measuring the voltage in the floating diffusions produced by the transferred charge from the global shutter photodiodes and reading the voltage onto the appropriate column circuit row by row. In step 514, the voltage readings are converted to digital global shutter image data using ADCs of the signal processing circuitry 204 and the digital global readout image data are then stored in memory. The memory in which such pixel data are stored may be, for example, memory 108 of digital camera 100, or an internal memory of the image sensor 104.

The integration of charge for the rolling shutter photodiodes begins row by row in step 516. This part of the process involves resetting and sampling the corresponding floating diffusions in step 518 row by row. After integration is complete for each rolling shutter pixel in a row, charge is transferred from the rolling shutter photodiodes to the floating diffusions within the row, as indicated in step 520. Although not indicated in the figure, the transfer gates of the rolling shutter photodiodes are turned off row by row after the charge is transferred. The readout operation for the rolling shutter photodiodes then begins in step 522 by measuring the voltage produced in the floating diffusions by the transferred charge from the rolling shutter photodiodes and reading the measured voltages onto the appropriate column circuit row by row. In step 524, the voltage measurements are converted to digital rolling shutter image data using ADCs of the signal processing circuitry 204 and the digital global readout image data are then stored in memory, which as noted above may be memory 108 of digital camera 100, or an internal memory of the image sensor 104.

It is to be appreciated that the particular process steps of FIG. 5 are presented by way of example only, and other types of image data capture processes may be used in alternative embodiments of the invention. For example, steps 512 and 522 may utilize other types of measurement arrangements than those specifically listed.

The global shutter image data may be processed along with the rolling shutter image data in order to generate a final image. For example, a global shutter image generated from the global shutter pixels may be used to correct for motion artifacts or other artifacts in a rolling shutter image generated from the rolling shutter pixels. In the FIG. 4 example, the global shutter image is captured very quickly using the panchromatic pixels to eliminate artifacts such as motion blur and smear, and the rolling shutter image is captured with a longer exposure time to provide good color performance and low noise. A final image generated from combination of the global shutter and rolling shutter images has fewer artifacts and significantly higher quality than an image generated using conventional rolling shutter techniques.

Exemplary techniques for generating a final image or other improved image from the global shutter image data and rolling shutter image data will now be described in greater detail. Since the global shutter image has an exposure time that is different both in duration and timing from that of the rolling shutter image, camera motion or object motion in the scene may cause misalignment between the image content contained in the global shutter image and the image content contained in the rolling shutter image. In one embodiment, an improved image is formed by using the global shutter image as a baseline image to guide the correction of motion artifacts in the rolling shutter image. The global shutter image and the rolling shutter image can then be used separately or combined to form a further improved image. The processing operations associated with generation of one or more improved images from the global shutter and rolling shutter images can be implemented, by way of example, in the signal processing circuitry 204 of image sensor 104.

The correction of the motion artifacts in the rolling shutter image may be accomplished using motion estimation and compensation techniques in which the differences between the global shutter image and a rolling shutter image are determined and then portions of the rolling shutter image are moved to align them with the global shutter image. Conventional aspects of such motion estimation and compensation techniques are known in the art, and may involve, for example, use of affine models, block-based translational motion models or dense motion fields from optical flow algorithms.

As a more particular example of motion estimation and compensation suitable for use in a memory-constrained embodiment of the invention, a small number of image sensor pixel rows may be read out and buffered in memory at a given time. A block-based translational motion model is then used to provide a fast, local estimation of motion. The size of the blocks and the search range used to match blocks within the global shutter image to blocks within the rolling shutter image can be chosen in part depending on the number of rows of pixels available in the buffer. For example, the images can be divided into 8×8 blocks and searched with a motion range of up to 4 pixels to identify a matching block. Block-matching statistics can be kept for each block as offsets between matching blocks that are used in subsequent analysis. Such statistics may include the error associated with the preferred match, as well as the ratio between the average error across all offsets and the minimum error.

Once motion offsets have been determined for all blocks in the current group of rows, the offsets are further processed to enforce regularity and reduce the influence of noise on the motion estimates. This can be achieved by median filtering the motion offsets, using available motion data from current and previous rows. In order to avoid median filtering across strong edges, the computed block-matching statistics can be used to pass blocks unchanged through the median filter. In particular, a high ratio between the average error and minimum error suggests a strong match and substantial image content. Blocks whose average error to minimum error ratio exceeds a preset threshold are excluded from the median filter.

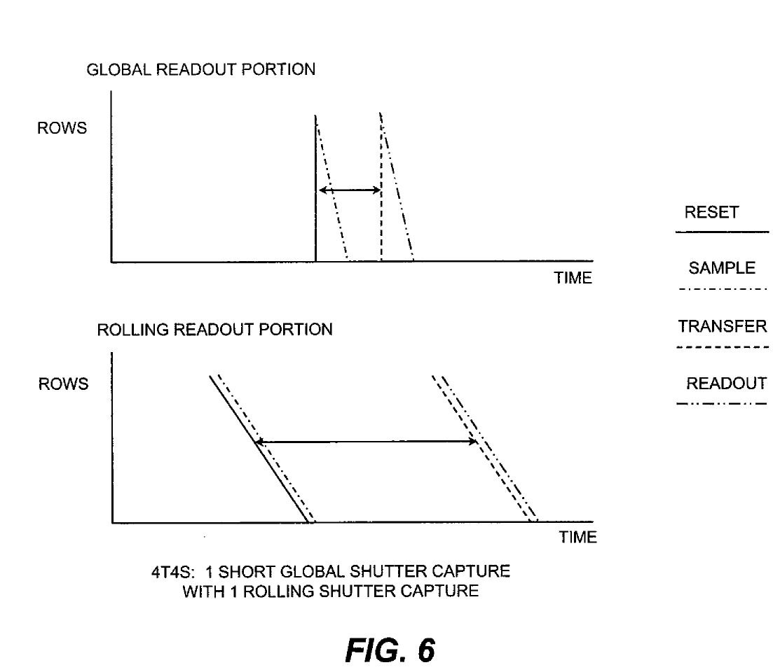

Different motion estimation techniques can be used in alternative implementations. In an embodiment in which buffer memory is less constrained and the entire, or nearly entire, image can be stored in memory prior to processing, more complicated motion analysis can be used. For example, optical flow algorithms can be used to generate a motion vector for every pixel. Alternatively, larger search ranges can be used for block motion estimation. In a scenario in which the global shutter image exposure time is roughly centered within a longer exposure time of the rolling shutter image, as in the embodiment of FIG. 6, motion estimation and compensation can be skipped entirely or else used with a reduced search range, reducing the overall complexity of the processing algorithms.

Once the motion estimation is completed, the rolling shutter image is adjusted according to the motion estimates to align it with the global shutter image. This adjustment of the rolling shutter image can include an adjustment for motion that varies row by row to align features within the image to the global shutter image. The adjustment for motion can be a lateral shift of portions of the image to compensate for the effects of motion and the fact that rows of the global shutter image are captured at different times. The adjusted rolling shutter image can then be used by itself or it can be combined with the global shutter image to form an improved combined image with a higher signal-to-noise ratio. This may be accomplished, for example, through the use of a stacking approach, which generally involves adding together code values for similar pixel locations within the images. Additionally or alternatively, the global shutter image, since it was captured with a shorter exposure time so that motion artifacts are reduced, can be used to help guide sharpening of the edges within the rolling shutter image.

Numerous other techniques may be used to produce one or more improved images using the global shutter and rolling shutter images. As indicated previously, these techniques may be implemented at least in part in the signal processing circuitry 204 of the image sensor 104.

FIGS. 6 through 8 illustrate other examples of image data capture processes that may be implemented in the FIG. 1 digital camera for pixel array 200 comprising the 4T4S pixel arrangement shown in FIGS. 3A and 3B. In each of these additional examples, a global shutter process is applied to a first set of pixels of the pixel array and a rolling shutter process is applied to a second set of pixels of the pixel array, as in the example described in conjunction with FIGS. 4 and 5. It will again be assumed for these and other examples herein that the first set of pixels comprises the panchromatic pixels and the second set of pixels comprises the color pixels, although as indicated previously numerous other groupings of pixels into sets are possible.

Referring now to FIG. 6, an image data capture process is shown in which an exposure time of the global shutter photodiodes fully overlaps with an exposure time of the rolling shutter photodiodes. In this case, the reset of the rolling shutter photodiodes occurs before the reset of the global shutter photodiodes while the transfer of charge from the global shutter photodiodes and associated readout of the floating diffusions occurs before the transfer of charge from the rolling shutter photodiodes and associated readout of the floating diffusions. The process is otherwise configured in a manner similar to the process of FIGS. 4 and 5.

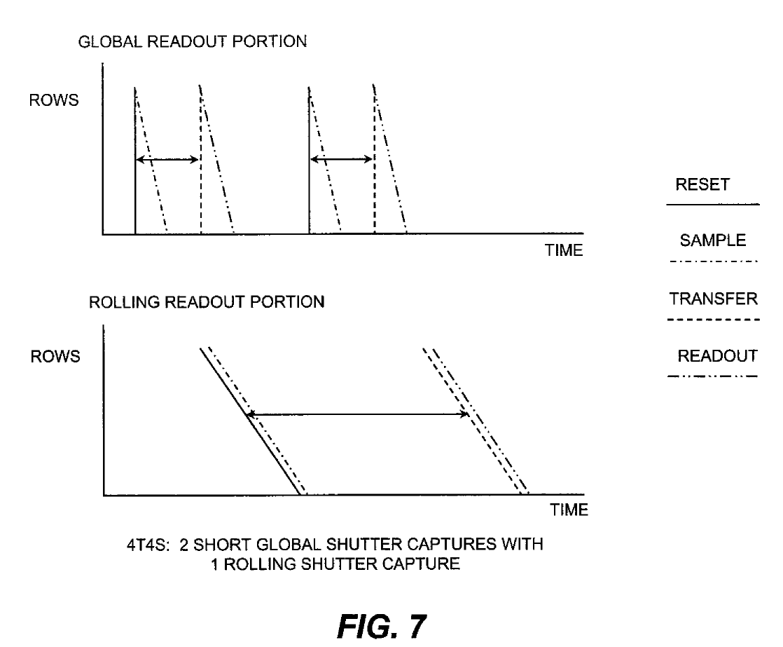

FIG. 7 shows an example of an arrangement in which two short global shutter captures are performed in conjunction with a single rolling shutter capture. This is one example of a more general arrangement in which multiple images are captured from the first set of pixels using the global shutter process during a period of time in which a single image is captured from the second set of pixels using the rolling shutter process. Other examples of an arrangement of this type may capture three or more global shutter images over a period of time in which only a single rolling shutter image is captured. The pixels used for the multiple global shutter captures can be the same pixels or different pixels.

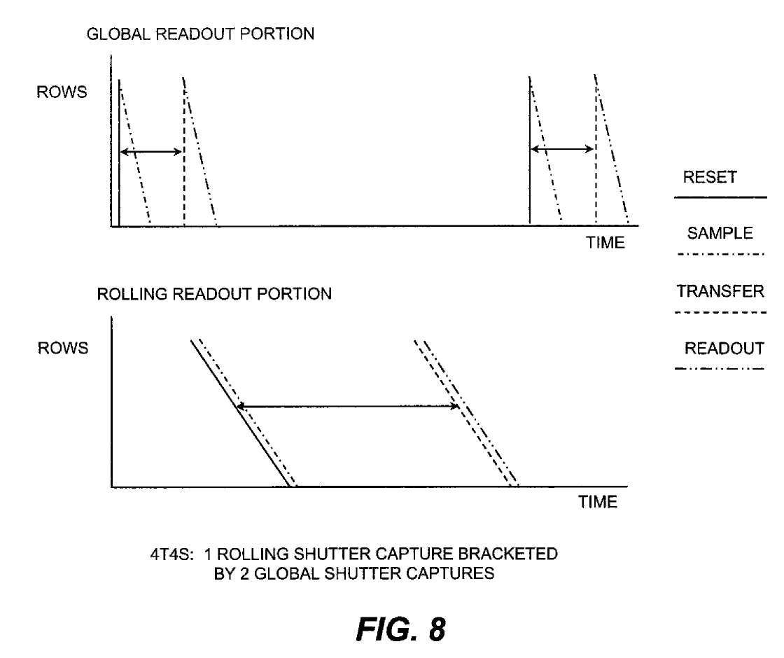

In the FIG. 7 example, the second global shutter capture has an exposure time which fully overlaps an exposure time of the rolling shutter capture. FIG. 8 shows an alternative arrangement in which there is no such overlap of global shutter exposure times with the rolling shutter exposure time. Instead, in the arrangement of FIG. 8, the rolling shutter capture is surrounded or bracketed by two global shutter captures. As in the FIG. 4 example, the readout time of the global shutter image capture process in FIG. 8 at least partially overlaps the exposure time of the rolling shutter image capture process as applied to the initial rows for which image data is captured using the rolling shutter process.

It should be noted that in an overlapped capture arrangement such as that illustrated in FIGS. 6 or 7, it is not necessary to sample the floating diffusions twice. It is instead possible to sample the floating diffusions only once. This single sampling could be, for example, at the beginning of the integration in order to avoid introducing noise or in the middle of the integration to get the sampling closest in time to the readout for accuracy.

FIGS. 9 through 11 illustrate further examples of image data capture processes that may be implemented in the FIG. 1 digital camera for pixel array 200, but in these examples comprising a 4T2S pixel arrangement such as that shown in FIG. 3C rather than the 4T4S pixel arrangement of FIGS. 3A and 3B.

FIG. 9 shows a single global shutter capture with a single rolling shutter capture for a pixel array with a 4T2S pixel arrangement. As is apparent from the figure the use of two floating diffusions within the four pixel cell enables overlapped sampling and readout of at least some of the global shutter pixels and the rolling shutter pixels. As shown in FIG., the exposure time of the global shutter capture at least partially overlaps an exposure time of the rolling shutter capture, and the sampling of the floating diffusions for the global shutter pixels is conducted substantially simultaneously with the sampling of the floating diffusions for the rolling shutter pixels.

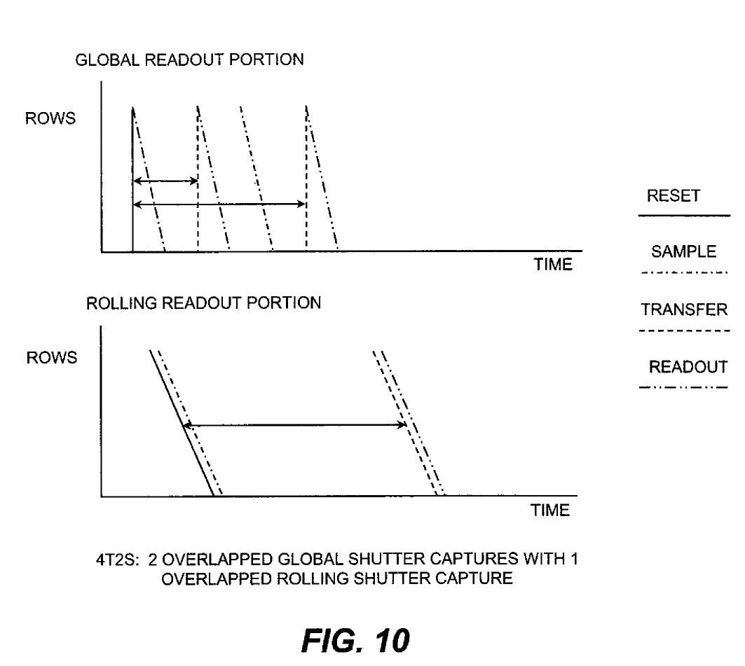

FIG. 10 illustrates an example with a 4T4S arrangement wherein two global shutter captures can overlap with each other and a single rolling shutter capture. The two overlapping global shutter captures are applied to separate sets of pixels. Thus, in the FIG. 10 example, the pixels of the pixel array are divided into three sets, with two of the sets being subject to respective global shutter processes and one of the sets being subject to the rolling shutter process. Both of the global shutter processes have exposure times that partially overlap with an exposure time of the rolling shutter process. Also, the exposure times of the two global shutter processes are not the same, with one of them having a significantly longer exposure time than the other. The difference in exposure times and the timing of the readouts of the two global shutter images is limited only by the readout capabilities of the image sensor and the associated capabilities of the digital camera.

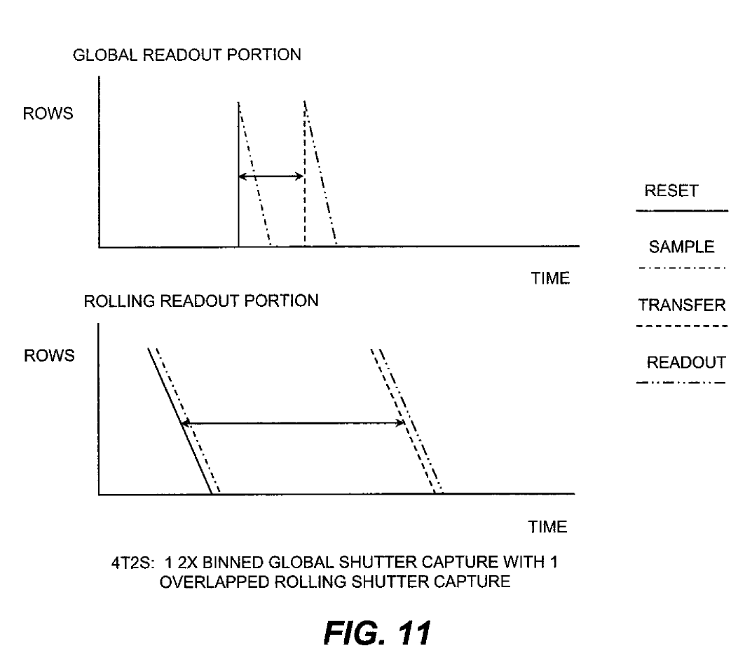

In the example of FIG. 11, a single global shutter capture has an exposure time that is fully overlapped with an exposure time of the rolling shutter capture. The global shutter capture in this example is a binned global shutter capture, with a binning factor of two or more. Binning is generally accomplished by transferring the charge from more than one photodiode into a single floating diffusion. In binning with a binning factor of two, the charge from two photodiodes is transferred into a single floating diffusion in order to decrease noise and increase sensitivity in the binned image.

The global and rolling shutter images captured using the techniques illustrated in FIGS. 6 through 11 can also be processed to generate a final image or other type of improved image in a manner similar to that described above in the context of FIGS. 4 and 5.

As mentioned previously, the particular image data capture processes described in conjunction with FIGS. 4 through 11 are presented by way of example only, and other embodiments can use alternative image data capture processes in which image data is captured from at least one set of pixels using a global shutter process and image data is captured from at least one other set of pixels using a rolling shutter process.

The above-described illustrative embodiments advantageously provide significant reductions in motion artifacts and other artifacts commonly associated with conventional use of rolling shutters, without significantly increasing the cost or complexity of the image sensor or its associated digital imaging device.

The invention has been described in detail with particular reference to certain illustrative embodiments thereof, but it will be understood that variations and modifications can be effected within the scope of the invention as set forth in the appended claims. For example, the disclosed techniques can be adapted for use with other types of image sensors and implemented using other arrangements of image sensor circuitry. Thus, the particular types of signal generators and drive circuitry used may be varied in alternative embodiments. Also, features such as the particular types of CFA patterns that are used, the configuration of the pixel array, and the image data capture operations such as reset, sample, transfer and readout, may be altered in other embodiments to accommodate the needs of other image capture devices and operating modes. Furthermore, many alternative techniques may be used to combine or otherwise process global shutter and rolling shutter images to generate a final image or one or more other improved images. These and other alternative embodiments will be readily apparent to those skilled in the art.

Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible. For example, an image sensor includes an array of pixels comprising at least first and second sets of pixels, and image sensor circuitry coupled to the pixel array and comprising a signal generator for controlling capture of image data from the first set of pixels of the pixel array using a global shutter process and controlling capture of image data from the second set of pixels of the pixel array using a rolling shutter process, the pixels of the second set being different than the pixels of the first set. The pixel array can include a plurality of floating diffusions with each floating diffusion being associated with only one of the pixels. The pixel array can comprise a plurality of floating diffusions with each floating diffusion being shared between multiple pixels. The floating diffusions can be shared between four of the pixels or two of the pixels. The floating diffusions can be shared between at least one pixel of the first set of pixels and at least one pixel of the second set of pixels such that the given floating diffusion is used for capture of image data from said at least one pixel of the first set of pixels using the global shutter process and is also used for capture of image data from said at least one pixel of the second set of pixels using the rolling shutter process. A readout time of image data captured from the pixels of the first set using the global shutter process can at least partially overlap an exposure time of the rolling shutter process. An exposure time of the global shutter process can at least partially overlap an exposure time of the rolling shutter process. Multiple images can be captured from the first set of pixels using the global shutter process during a period of time in which a single image is captured from the second set of pixels using the rolling shutter process. The pixel array can further include a third set of pixels, with the pixels of the third set being different than the pixels of the first and second sets. The signal generator can be operative to control capture of image data from the third set of pixels utilizing an additional global shutter process. The additional global shutter process utilized in capturing image data from the third set of pixels can have an exposure time which is different than that of the global shutter process utilized in capturing image data from the first set of pixels. The additional global shutter process utilized in capturing image data from the third set of pixels can have an exposure time which at least partially overlaps an exposure time of the global shutter process utilized in capturing image data from the first set of pixels. The pixels of the pixel array can comprise color pixels or panchromatic pixels. The first group of pixels from which image data is captured using the global shutter process can be substantially entirely panchromatic pixels. The signal generator can comprise drive circuitry configured to generate at least reset gate, transfer gate and row select signals for application to the pixel array in controlling said global shutter process and said rolling shutter process. The image sensor can comprise signal processing circuitry configured to process a global shutter image comprising the image data captured from the first set of pixels of the pixel array using the global shutter process and a rolling shutter image comprising the image data captured from the second set of pixels of the pixel array using the rolling shutter process, in order to generate from the global shutter image and the rolling shutter image at least one additional image.

A digital imaging device can include the image sensor as described above and one or more processing elements configured to process outputs of the image sensor to generate a digital image.

A method of capturing image data from an image sensor comprising a pixel array can comprise capturing image data from a first set of pixels of the pixel array using a global shutter process, and capturing image data from a second set of pixels of the pixel array using a rolling shutter process, the pixels of the second set being different than the pixels of the first set. Multiple images can be captured from the first set of pixels using the global shutter process during a period of time in which a single image is captured from the second set of pixels using the rolling shutter process. Image data can be captured from a third set of pixels of the pixel array utilizing an additional global shutter process, the pixels of the third set being different than the pixels of the first and second sets. A global shutter image comprising the image data captured from the first set of pixels of the pixel array using the global shutter process can be processed and a rolling shutter image comprising the image data captured from the second set of pixels of the pixel array using the rolling shutter process can be processed in order to generate from the global shutter image and the rolling shutter image at least one additional image. The additional image can comprise a corrected rolling shutter image that is corrected for motion artifacts using the global shutter image. The additional image can comprise an image generated by combining at least a portion of the global shutter image with at least a portion of the rolling shutter image.

### PARTS LIST

100 digital camera

102 imaging stage

104 image sensor

106 processor

108 memory

110 display

112 input/output (I/O) elements

200 pixel array

202 controllable signal generator

204 signal processing circuitry

300 pixel

302 photodiode

304 transfer gate

306 reset gate

308 output transistor

310 row select transistor

312 floating diffusion

400, 402 exposure tines

404 readout time

500-524 image data capture process steps

1. An image sensor comprising:
an array of pixels comprising at least first and second sets of pixels; and
image sensor circuitry coupled to the pixel array and comprising a signal generator for controlling capture of image data from the first set of pixels of the pixel array using a global shutter process and controlling capture of image data from the second set of pixels of the pixel array using a rolling shutter process, the pixels of the second set being different than the pixels of the first set.

2. The image sensor of claim 1 wherein said pixel array comprises a plurality of floating diffusions with each floating diffusion being associated with only one of the pixels.

3. The image sensor of claim 1 wherein said pixel array comprises a plurality of floating diffusions with each floating diffusion being shared between multiple pixels.

4. The image sensor of claim 3 wherein a given one of said floating diffusions is shared between four of the pixels.

5. The image sensor of claim 3 wherein a given one of said floating diffusion is shared between two of the pixels.

6. The image sensor of claim 3 wherein a given one of said floating diffusions is shared between at least one pixel of the first set of pixels and at least one pixel of the second set of pixels such that the given floating diffusion is used for capture of image data from said at least one pixel of the first set of pixels using the global shutter process and is also used for capture of image data from said at least one pixel of the second set of pixels using the rolling shutter process.

7. The image sensor of claim 1 wherein a readout time of image data captured from the pixels of the first set using the global shutter process at least partially overlaps an exposure time of the rolling shutter process.

8. The image sensor of claim 1 wherein an exposure time of the global shutter process at least partially overlaps an exposure time of the rolling shutter process.

9. The image sensor of claim 1 wherein multiple images are captured from the first set of pixels using the global shutter process during a period of time in which a single image is captured from the second set of pixels using the rolling shutter process.

10. The image sensor of claim 1 wherein said pixel array further comprises a third set of pixels, with the pixels of the third set being different than the pixels of the first and second sets, and wherein the signal generator is operative to control capture of image data from the third set of pixels utilizing an additional global shutter process.

11. The image sensor of claim 10 wherein said additional global shutter process utilized in capturing image data from the third set of pixels has an exposure time which is different than that of the global shutter process utilized in capturing image data from the first set of pixels.

12. The image sensor of claim 10 wherein said additional global shutter process utilized in capturing image data from the third set of pixels has an exposure time which at least partially overlaps an exposure time of the global shutter process utilized in capturing image data from the first set of pixels.

13. The image sensor of claim 1 wherein said pixels of the pixel array comprise color pixels and panchromatic pixels, and further wherein the first group of pixels from which image data is captured using the global shutter process is comprised substantially entirely of panchromatic pixels.

14. The image sensor of claim 1 wherein the signal generator comprises drive circuitry configured to generate at least reset gate, transfer gate and row select signals for application to the pixel array in controlling said global shutter process and said rolling shutter process.

15. The image sensor of claim 1 further comprising signal processing circuitry configured to process a global shutter image comprising the image data captured from the first set of pixels of the pixel array using the global shutter process and a rolling shutter image comprising the image data captured from the second set of pixels of the pixel array using the rolling shutter process, in order to generate from the global shutter image and the rolling shutter image at least one additional image.

16. A method of capturing image data from an image sensor comprising a pixel array, the method comprising the steps of:
capturing image data from a first set of pixels of the pixel array using a global shutter process; and
capturing image data from a second set of pixels of the pixel array using a rolling shutter process, the pixels of the second set being different than the pixels of the first set.

17. The method of claim 16 wherein multiple images are captured from the first set of pixels using the global shutter process during a period of time in which a single image is captured from the second set of pixels using the rolling shutter process.

18. The method of claim 16 further comprising the step of capturing image data from a third set of pixels of the pixel array utilizing an additional global shutter process, the pixels of the third set being different than the pixels of the first and second sets.

19. The method of claim 16 further comprising the step of processing a global shutter image comprising the image data captured from the first set of pixels of the pixel array using the global shutter process and a rolling shutter image comprising the image data captured from the second set of pixels of the pixel array using the rolling shutter process, in order to generate from the global shutter image and the rolling shutter image at least one additional image.

20. The method of claim 19 wherein the additional image comprises a corrected rolling shutter image that is corrected for motion artifacts using the global shutter image.

21. The method of claim 19 wherein the additional image comprises an image generated by combining at least a portion of the global shutter image with at least a portion of the rolling shutter image.

22. A digital imaging device comprising:
an image sensor; and
one or more processing elements configured to process outputs of the image sensor to generate a digital image;
wherein said image sensor comprises:
an array of pixels comprising first and second sets of pixels; and
image sensor circuitry coupled to the pixel array and comprising a signal generator for controlling capture of image data from the first set of pixels of the pixel array using a global shutter process and controlling capture of image data from the second set of pixels of the pixel array using a rolling shutter process, the pixels of the second set being different than the pixels of the first set.

23. The digital imaging device of claim 22 wherein said digital imaging device comprises a digital camera.
